(19) United States
(12) Patent Application Publication
(10) Pub. No.: US 2008/0087509 A1
(43) Pub. Date: Apr. 17, 2008

(54) Method and Device for Actuating a Braking System, in Particular a Parking Brake of a Motor Vehicle

(76) Inventors: Alexander Kalbeck, Burglengenfeld (DE); Damiano Molfetta, Wetzikon (CH)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/719,084

(22) PCT Filed: Nov. 17, 2005
(86) PCT No.: PCT/EP05/56035

§ 371 Date: May 10, 2007

(30) Foreign Application Priority Data
Nov. 18, 2004 (DE) 10 2004 055 721.7

(51) Int. Cl. B60T 13/74; B60T 7/12

(52) U.S. Cl. 188/156; 701/70

(57) ABSTRACT

To securely park a motor vehicle (1) a parking brake (5) is often used, the brake actuating a hydraulically or electrically-assisted braking system (5, 5a) by means of a control button. If a speed signal is not available the reliable functioning of the parking brake (5) is no longer guaranteed. To activate the parking brake (5), the control button (2) is depressed for least a predetermined time period, the displacement mode of the motor vehicle (1) is detected using a signal of a further device (3,4, 6 to 9) and the parking brake (5) is only activated if the motor vehicle (1) has attained a predetermined limit value for the displacement mode.

### CROSS-REFERENCE TO RELATED APPLICATIONS

This application is a U.S. national stage application of International Application No. PCT/EP2005/056035 filed Nov. 17, 2005, which designates the United States of America, and claims priority to German application number 10 2004 055 721.7 filed Nov. 18, 2004, the contents of which are hereby incorporated by reference in their entirety.

### TECHNICAL FIELD

The invention is based on a method and a device for actuating a braking system for a stationary motor vehicle, in particular a parking brake.

### BACKGROUND

To securely park a motor vehicle a parking brake is often used for an automobile, but also for truck or omnibus, with said brake being actuated by means of a manual control button or automatically by a hydraulically or electrically-assisted braking system. In this situation the braking system exerts a continuous static braking effect on the braking system (static braking mode) and in doing so has the task, for safety reasons for example, of preventing an undesired movement of the stationary motor vehicle. For an automatically operating braking system in particular, to establish the movement status, i.e. at least a position in which the motor vehicle has practically come to a standstill, a speed signal of a speed generator is needed so that the parking brake cannot be applied unintentionally while driving or only in a dynamic braking mode provided. In general a vehicle which is practically at rest or is stationary is referred to as being in the static state, in which there is provision for a normally continuous application of the parking brake. If the motor vehicle is in the dynamic state, the parking brake is activated in a controlled manner and can also be released again after it has been actuated.

In the absence of a speed signal, if for example there is a malfunction in the electrical system, or if this problem is not prevented by the signal design of the motor vehicle, or if generally no corresponding signals are present in the motor vehicle or if a control unit is in a “sleep” mode from which it cannot be woken up, the secure detection of the motor vehicle being stationary can no longer be guaranteed using the speed signals, so that under some circumstances an increased safety risk arises and accidents, damage to the braking system and also to the motor vehicle can occur.

The manner in which this problem has previously been solved is for the driver to initially use the normal service brake (foot brake) to brake their vehicle dynamically until it comes to a halt and to actuate the parking brake thereafter. This manual method is naturally especially dependent on the alertness of the driver and therefore cannot always be employed to optimum effect. Accidents with serious consequences have thus resulted if for example a stopped motor vehicle has stated to move again by itself at a road junction.

It is further known that, with deactivated vehicle control devices, a “wake-up” signal is sent automatically to a corresponding control unit. This control unit then sends the corresponding signals to the parking brake. This method however requires significant increased technological outlay with the associated extra costs.

### SUMMARY

The underlying object of the invention is to improve the function of the braking system of a motor vehicle, especially that of the parking brake.

According to an embodiment, a method for actuating a parking brake of a motor vehicle which is in a static state, wherein the parking brake transmits its braking effect through a mechanically, hydraulically or electrically-supported system to at least one brake actuator of the motor vehicle, the method comprising the step of triggering a static braking process through manual actuation of a control button, wherein the control button being actuated manually for a predetermined time to initiate the static braking process, wherein the braking effect of the parking brake only comes into force, if—regardless of the presence of a signal of a speed measuring device—a corresponding current movement status of the motor vehicle is detected by evaluating the status of a brake pedal wherein, for initiating the static braking process, the brake pedal being actuated almost simultaneously with the control button or within a predetermined period of time before the actuation of the control button for the parking brake.

### BRIEF DESCRIPTION OF THE DRAWINGS

A number of exemplary embodiments are depicted in the drawing and explained in greater detail in the subsequent description.

FIG. 1 shows a flowchart of a first exemplary embodiment,

FIG. 2 shows a flowchart of a second exemplary embodiment,

FIG. 3 shows a flowchart of a third exemplary embodiment,

FIG. 4 shows a flowchart of a fourth exemplary embodiment and

FIG. 5 shows a block diagram of a device according to an embodiment.

### DETAILED DESCRIPTION

The advantage of the method according to an embodiment for actuation of a braking system on a stationary motor vehicle or the device with the characterizing features of the coordinated claims 1 and 9, is that the parking brake functions reliably even if no speed signal of a speed signal generator located in the motor vehicle is available. For determining the current movement status of the motor vehicle a suitable information signal which can be used for determination of the movement status of the motor vehicle is supplied by a further independent vehicle device. It is also seen as especially advantageous that a longer actuation of the control button for the parking brake is able to prevent the parking brake perhaps accidentally being applied by brief contact with the control button without direct speed information. To further increase security there is provision for the parking brake to only then be applied permanently if the motor vehicle is in the static movement mode and/or reaches a predetermined limit value for this movement mode.

The measures described in the dependent claims give advantageous developments and improvements of the method specified in the coordinated claims 1 and 9 or of the device for actuating the parking brake respectively. It is seen as particularly advantageous for a further control device of the motor vehicle to be actuated for static activation of the parking brake. In the simplest case the brake pedal can preferably be actuated. As a rule the brake pedal must be actuated in any event if the moving vehicle needs to decrease its speed in order to come to a standstill or to assume a static state.

To fulfill desired safety aspects, it is sufficient in the simplest case for the brake pedal to be actuated almost simultaneously with the parking brake and/or for a braking moment to be present through the service brake. The result of this is that a moving motor vehicle is initially decelerated with the service brake or signals to the driver that a braking process or an activation of the parking brake is intended. The motor vehicle is thus in the static state or can thus be braked in a controlled manner until it has reached this state and then the parking brake starts to function.

Alternatively there is provision for the brake pedal to have been actuated a predetermined period of time before the acceptance of the request for the parking brake. This increases the likelihood that, when the parking brake is activated, the motor vehicle is only still moving at a very low speed or is already stopped.

For detection of the current driving status there is provision for using signals from suitable devices of the motor vehicle which are already available. Thus the signals of a wheel sensor, of an acceleration sensor, a gear selected especially with an automatic gearbox, height status information, of a tire sensor and/or a position signal of a positioning device, for example a GPS navigation system, can be used. Naturally signals of a driver information system, for example of a driver assistance system, of a radar, ultrasound, laser, infrared radar, camera system or of a chassis-controller, can also be used.

In a further embodiment there is provision for the activation of the parking brake after an appropriate request to only be started after a predetermined delay. The predetermined delay time means that there is a greater likelihood of the motor vehicle having come to a halt before the onset of the effect of the parking brake.

An advantageous development and an improvement consist of the application of the parking brake being undertaken in a controlled manner, with the parking brake being controlled with a reduced application speed by means of a predetermined curve for the braking force. Such a control curve can for example be embodied as a rising, modulatable curve.

In the absence of a speed signal there is provision for an appropriate optical or acoustic indication to be output to the driver to tell them to operate the parking brake.

The control can also be controlled with a voice input or voice output system.

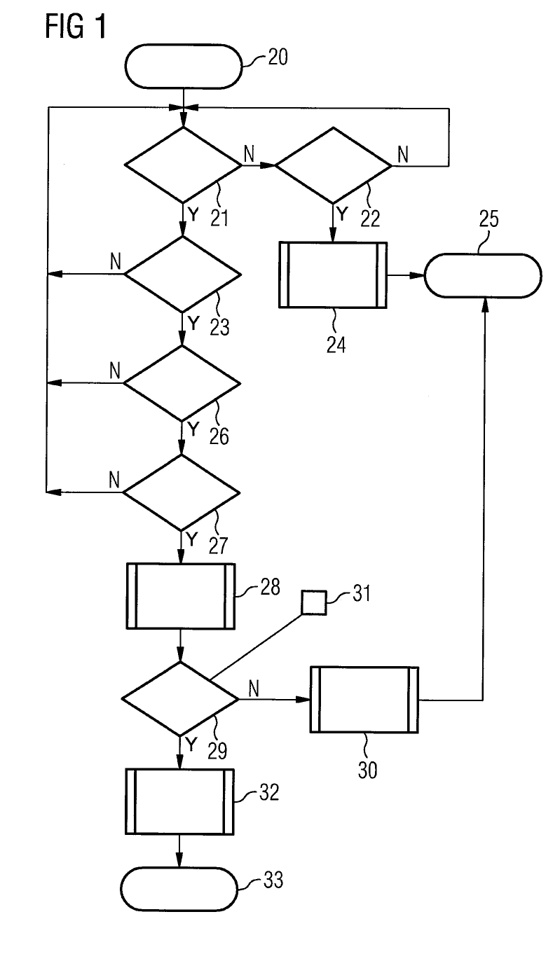

For the first exemplary embodiment in accordance with FIG. 1, a schematic flowchart reproduces the functioning of the method or of the device respectively for parking brake actuation. The exemplary embodiment of FIG. 1 shows the case in which for example, because of an electrical error, no signal of a speed measurement device is present. The flowchart contains an algorithm which is processed in the form of a software program by a control unit of the motor vehicle, as described in greater detail below

The program starts in position 20, after it has been established by the control device that the signal for the current speed of the vehicle is absent and the parking brake is not already in a static braking mode. In position 21 a check is made as to whether the brake pedal was pressed and/or the dynamic service brake is effective. For N (no) a check is made in position 22 as to whether the control button for the electrically or hydraulically-operating parking brake was pressed or a request was made for its application. If this is the case (with Y) dynamic braking and not static braking is initiated in position 24, since it is assumed that the motor vehicle is still moving too quickly. If necessary an indication can be provided for actuating the brake for the static case, for example optically by illuminating a corresponding display or acoustically. Subsequently the program jumps in position 25 to the end of the program or the cycle begins again at position 20.

If, on the other hand, in accordance with position 22 the control button for the parking brake was not actuated, the program jumps back to position 21.

If however a control device, for example the brake pedal, was pressed in position 21, then the program determines in position 23 how long the brake time is lasting and whether a predetermined period of time has elapsed. The predetermined period of time is for example determined as a function of a minimal deceleration of the motor vehicle or can be derived from the values last determined in the positive state of the system.

In position 26 a check is made as to whether the control button for the parking brake was pressed or whether there is a request present for applying the parking brake. In the Y branch the program queries in position 27 whether the control button was pressed for longer that a predetermined period of time, i.e. a check is made as to whether the request time determined for intended braking was fulfilled. If the N branch indicates that this is not the case, the program jumps both in position 26 and also in position 27 back to the request in position 21.

If on the other hand in position 27 the conditions are fulfilled with Y, then in position 28 the parking brake is activated and a static braking mode of the motor vehicle is initiated.

Optionally a check is made in position 29 as to whether the period of time for the request time corresponding to a delay time (for example for taking account of the actuator movement) is fulfilled. If it is not, the parking brake is released again in position 30. In the Y branch in accordance with position 32 the parking brake is activated and a static braking mode initiated. This process is maintained until such time as the signal to release the brake is present.

In position 31 the option is provided of expanding the request to further conditions, for example requesting a delay time for the initiation of the braking process.

In position 33 the program is ended or the cycle can begin again in position 20.

In an alternate embodiment there is provision for using a voice input or voice output system to control the parking brake. Furthermore the corresponding operating instructions can be output for the driver in the absence of a speed signal. Furthermore a request of a control unit can lead to an automatic actuation of the parking brake.

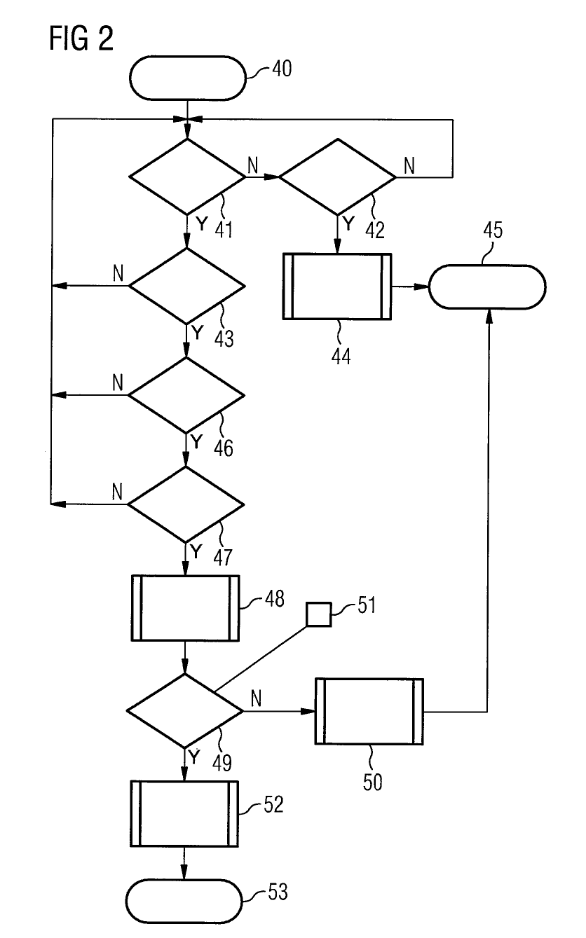

FIG. 2 shows a flowchart of a second exemplary embodiment, in which it is assumed that the motor vehicle is equipped with an automatic gearbox and also there is no speed signal available. For automatic gearboxes the gearshift is put into the park setting.

The method for activating the parking brake operates according to a similar scheme to that previously explained in FIG. 1. After the start of the program in position 40, a check is made in position 41 as to whether the gearbox was switched to the park setting. For N the program queries in position 42 whether the control button for the parking brake was actuated, i.e. whether a request to activate the parking brake is present, i.e. whether for example there is an internal system request or if the control button for the parking brake was actuated. If this is not the case (N), the program jumps back to the request in position 41. With Y in position 42 the program jumps to position 44 and dynamic braking of the motor vehicle is initiated. As a rule no static braking is initiated in this case. However an optical or acoustic indication for the actuation of the parking brake or to put the gearbox into the park setting can be output. The program then jumps in position 45 to the end of the program or the cycle begins again in position 40.

If it was established in position 41 that the gearbox park setting has been selected, then in accordance with the Y path in position 43, a check is made as to whether the predetermined time interval for a minimum delay time was reached. For N the program jumps back to the request in position 41. For Y a check is made in position 46 as to whether a request to apply the parking brake is present. If there is no such request, the program jumps back to position 41 (path N). For the Y branch the program jumps to position 47 and a check is made as to whether the request time determined or prespecified was reached. In the case of N the program jumps back to position 41. For Y the static braking mode of the parking brake is activated in position 48. Optionally a check is made in position 49 as to whether the predetermined time interval of the request time has been exceeded for the brake actuator to be in its final position. With N the parking brake is released again in position 50 and the program is ended in position 45. Furthermore there is the option in position 51 of providing a further request.

If on the other hand the requested condition is met in position 49, then in position 52 (path Y) the parking brake is activated and a static braking process is initiated. In position 53 the program is ended or the cycle can begin again in position 40.

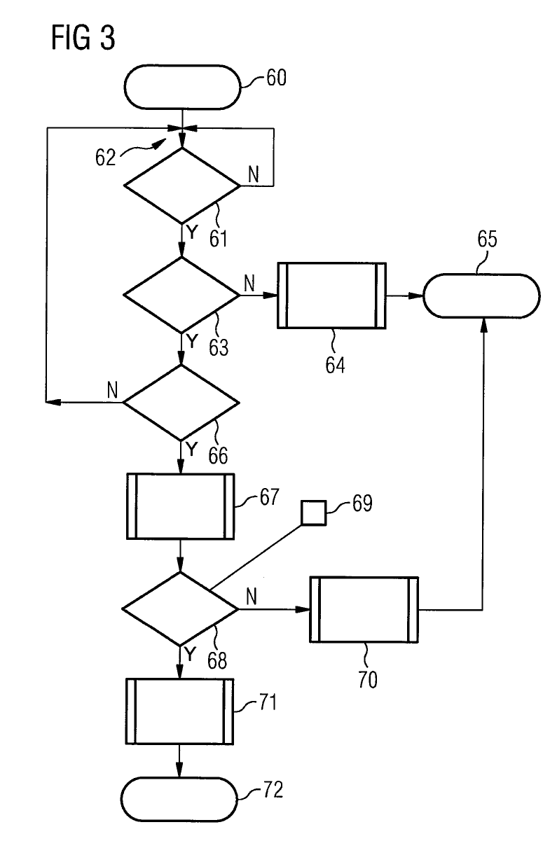

FIG. 3 shows a further flowchart of an exemplary embodiment. This functional sequence, by contrast with the two methods described above, executes according to a modified scheme. With this exemplary embodiment a signal of a further vehicle device, especially an acceleration signal for determination of the displacement status, especially of the stationary state of the motor vehicle, is evaluated. Once again the assumption is made that the driving state of the motor vehicle is not known and no speed signal is present and that the parking brake is not in the statically applied state.

The program starts in position 60 and in position 61 the program queries whether there is a request to apply the parking brake. If necessary in position 62 acceleration information, for example from an acceleration sensor, rpm sensor or similar, can first be checked for its behavior and sequence and/or a learning curve determined from it, which can then be used as the displacement status of the motor vehicle.

If in position 61 there is no request for the parking brake, the program jumps back to position 62. Otherwise a check is made in position 63 as to whether the current acceleration of the motor vehicle lies within the predetermined time limits or within the limits determined from the learning curve, which indicate a vehicle that is in the static displacement mode. If this is not the case (path N), then in position 64 a dynamic braking is initiated and in position 65 the program is ended or the cycle begins again in position 60. If necessary an alert can be output to the driver to actuate the parking brake.

Otherwise (path Y) a check is made in position 66 as to whether the request duration determined or predetermined is reached. For N the program jumps back to position 62. For Y the static application process of the parking brake begins in position 67. In position 68 a check can be made as to whether the minimum time interval for the brake request, e.g. the minimal duration of control button actuation for the parking brake has been reached, until the brake actuator has reached its final position and/or the acceleration values within this period or within another period determined in a similar manner to position 63 lie within value or time limits predetermined and/or determined from the learning curves. If this is not the case, then in position 70 the parking brake is released or a dynamic braking is initiated through the parking brake and the program is ended in position 65. For Y the static application process of the parking brake occurs in position 71. In position 69 the input of a further request is possible. In position 72 the program ends or the cycle is started again in position 60.

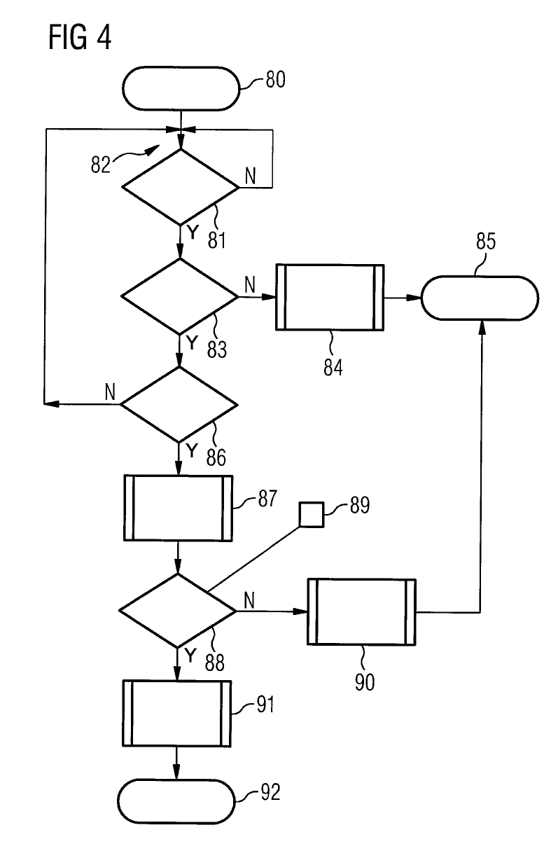

In the fourth exemplary embodiment in accordance with FIG. 4 it is assumed that likewise for a missing speed signal and unknown driving status a further vehicle device is used to determine that the motor vehicle is stationary. In this case assistance systems supporting the driver, for example signals of a positioning system (e.g. GPS system), of a speed control system (e.g. radar, ultrasound, laser, camera system), of a ride level system as well as environmental conditions are evaluated, which detect the relative movement of the motor vehicle by comparison with other objects or such like. With this information it can definitively be ascertained whether the motor vehicle is moving or stationary.

The program starts in position 80 and checks in position 81 whether there is a request to apply the parking brake, for example whether the control button for the parking brake was actuated. If necessary the signal characteristics of the sensor system can be checked beforehand in position 82. Learning curves can also be derived from these checks.

If there is no request in position 81 the program jumps back to position 82.

If on the other hand there is a braking request for the parking brake (path Y), then a check is made in position 83 as to whether the values of the sensor system lie within the determined or predetermined time or value limits. With N dynamic braking is initiated in position 84 and thereafter in position 85 the program is ended or the cycle begins again in position 80. With Y a check is made in position 86 as to whether the determined or predetermined time interval for the request is met. With N the program jumps back to position 82 and with Y the static brake application process begins in position 87.

A query is made in position 88 as to whether the duration of the request time is sufficient for the brake actuator to be in its final position and/or the values of the sensor system in this or in another determined time similar to position 83 lie within a predetermined value or time limit or within limits determined from the learning curves. If this is not the case, then in position 90 the parking brake is released again and the program is ended in position 85 or the time cycle can begin again in position 80. Optionally a further request can be inserted in position 89.

For path Y the parking brake is applied statically in position 91 and the program is ended in position 92.

In an alternate embodiment there is provision for the different functions of the exemplary embodiments shown to be able to be linked to each other in any given manner.

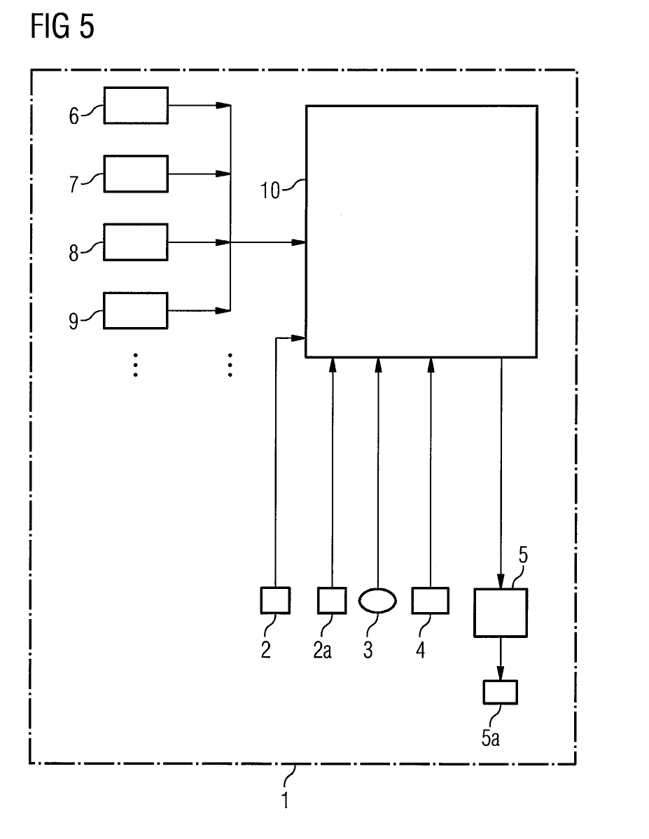

FIG. 5 shows in the form of a block diagram an device according to an embodiment for actuating a parking brake of a motor vehicle. In a modern motor vehicle, for example an automobile, a truck, an omnibus, a motor cycle or similar, a number of control devices are usually included for control of various motor, vehicle and driving dynamics functions, which with the aid of a stored program computer and corresponding sensors and generators use measured and predetermined data, setpoint curves and engine maps in order to control and to optimize the functions desired by the driver of the motor vehicle or safety-relevant functions.

For reasons of clarity FIG. 5 only shows a simplified and schematic presentation according to an embodiment. A motor vehicle 1 features a control device 10 with which the method in accordance with an embodiment can be controlled for actuation of a braking system 5, 5a, especially of a parking brake 5. The control device 10 is embodied with a stored program computer. An important component of the program is an algorithm, as has already been explained for FIGS. 1 to 4. With this program, after actuation of a control device, especially a control button 2 or an internal request of a control device 10, taking into account further driving functions, especially the current speed of the motor vehicle 1, accelerations etc., the parking brake 5 is activated if the motor vehicle 1 is in a static state or has at least reached a predetermined limit value for at least one movement status, for example the speed. According to the embodiments, it is of importance that for determination of the driving state, the control unit 10 is not dependent on the speed signals of a speed measurement device. Instead the control unit 10 derives the status information of the vehicle from signals of other devices (2 to 4, 6 to 9) of the motor vehicle, if no speed signal of the speed measurement device is available, as explained in greater detail below.

Naturally the function of the parking brake 5 is however also ensured if the speed measurement device detects its regular speed information and transmits it to the control device 10. In this case described signals and algorithms for plausibility checking of the speed information can be included.

The control unit 10 is connected on the output side to a braking system, especially a parking brake 5. The parking brake 5 is a servo system, which preferably operates hydraulically or electrically and converts the electrical commands received from the control unit 10 into hydraulic or electrical functions. The parking brake 5 actuates at least one brake actuator 5a, which exclusively brakes the movement of one or more wheels of the motor vehicle 1.

On the input side the control device 10 is connected to a series of detectors, sensors and other vehicle devices, with the signals of which vehicle status information can be obtained, so that the parking brake is activated first where possible if the motor vehicle is in the static state, i.e. its speed is preferably 0 Km/h.

Within the vehicle is a control button 2 preferably in the cockpit, arranged for easy access on the center console or on the steering wheel, which on shorter or longer actuation sends corresponding signals to the control unit 10 for activating the parking brake 5. To release the parking brake a button 2a is provided, which can also be identical to the control button 2 and is also connected to the control unit 10. Furthermore a brake pedal 3 is arranged in the motor vehicle 1, with which the service brake is normally actuated by the driver. The actuation of the brake pedal 3, especially the setting up or the value of the braking force is also transmitted to the control unit 10. For a motor vehicle 1 with an automatic gearbox 4 a corresponding signal about the gear stage selected, especially the parking stage (gear stage P) is sent to the control device 10.

For determining the vehicle status, especially the speed, the acceleration, a change in position or such like, the signals of further vehicle devices 6 to 9 are used, which are likewise transmitted to the control device 10. For example the signal of an acceleration sensor 6 is evaluated. If the acceleration value is constant, especially on actuation of the service brake, over a longer period, it can then be assumed that the vehicle is stationary, since changes in acceleration practically always occur when the vehicle is on the move because of the changing driving situations.

Furthermore, if the vehicle has a positioning system 7, for example a GPS-supported navigation system, an unchanged vehicle position can be evaluated for determining that the vehicle is stationary.

For motor vehicles with a driver assistance system 9, for example an adaptive speed control system with radar, ultrasound, laser, camera, a ride-level detector or similar sensor systems, the relative movement of objects in the motor vehicle's environment can be evaluated, as has already bee explained in relation to FIGS. 1 to 4 above. The use of the individual vehicle devices naturally depends on the existing equipment of the motor vehicle. This means that an additional sensor system for application of the method according to an embodiment may thus not be required.

What is claimed is:

1. A method for actuating a parking brake of a motor vehicle which is in a static state, wherein the parking brake transmits its braking effect through a mechanically, hydraulically or electrically-supported system to at least one brake actuator of the motor vehicle, the method comprising the step of:
triggering a static braking process through manual actuation of a control button, wherein the control button being actuated manually for a predetermined time to initiate the static braking process, wherein the braking effect of the parking brake only comes into force, if—regardless of the presence of a signal of a speed measuring device—a corresponding current movement status of the motor vehicle is detected by evaluating the status of a brake pedal, wherein, for initiating the static braking process, the brake pedal being actuated almost simultaneously with the control button or within a predetermined period of time before the actuation of the control button for the parking brake.

2. The method according to claim 1, wherein, for evaluation of the movement status a signal of a further signal generator of an acceleration sensor, of a positioning system, of an adaptive speed control system, of a driver assistance system and/or a ride level information of the motor vehicle is used.

3. The method according to claim 1, wherein the static braking process is initiated immediately after a predetermined period of time for pressing the control button has elapsed.

4. The method according to claim 1, wherein, after the actuation of the control button a static braking mode of the parking brake starts after a delay.

5. The method according to claim 4, wherein, the static braking mode is executed with a reduced application speed for the brake actuator, with the application speed being able to be controlled with a predetermined curve, for example with a rising modulatable curve.

6. A device for actuating a parking brake of a motor vehicle which is in a static state, wherein the parking brake, for transmission of its braking effect, is embodied by a mechanically, hydraulically or electrically-supported system on at least one braking actuator of the motor vehicle, comprising
a control button for manual actuation of the parking brake, with
a programmable control unit being operable such that a static braking process for the parking brake is only activated if the control button is actuated for a predetermined period of time, and a static brake activation is initiated—regardless of the presence of a signal of a speed measurement device, only if a current movement status for the motor vehicle is recorded through evaluation of the status of a brake pedal wherein, for the initiation of the static braking process the brake pedal being actuated almost simultaneously with the control button or within a predetermined period before the actuation of the control button for the parking brake.

7. The device according to claim 6, wherein, in the absence of a signal of a speed measurement device the movement status of the motor vehicle is determined with the aid of an acceleration sensor, of a positioning system, of an adaptive speed control system, of a driver assistance system, a height sensor system and/or information about a gear stage selected, especially for an automatic gearbox.

8. The device according to claim 6, wherein a control device for the parking brake is embodied as a voice input or voice output system.

9. The device according to claim 6, wherein, in the absence of a speed signal to the driver of the motor vehicle, an optical or acoustic indication is able to be output for actuation of the parking brake.

10. The method according to claim 1, wherein the signal is generated by a selected gear stage of an automatic gearbox.

11. A method for actuating a parking brake of a motor vehicle which is in a static state, comprising the step of:
determining a manual actuation of a control button for a predetermined time,
determining whether a brake pedal is actuated almost simultaneously with the control button or within a predetermined period of time before the actuation of the control button for the parking brake;
depending on said determinations, initiating the braking effect of the parking brake only if, regardless of the presence of a signal of a speed measuring device, a corresponding current movement status of the motor vehicle is detected by evaluating.

12. The method according to claim 11, wherein, for evaluation of the movement status a signal of a further signal generator of an acceleration sensor, of a positioning system, of an adaptive speed control system, of a driver assistance system and/or a ride level information of the motor vehicle is used.

13. The method according to claim 11, wherein the static braking process is initiated immediately after a predetermined period of time for pressing the control button has elapsed.

14. The method according to claim 11, wherein, after the actuation of the control button a static braking mode of the parking brake starts after a delay.

15. The method according to claim 14, wherein, the static braking mode is executed with a reduced application speed for the brake actuator, with the application speed being able to be controlled with a predetermined curve, for example with a rising modulatable curve.
